(19) United States
(12) Patent Application Publication
(10) Pub. No.: US 2026/0135073 A1
(43) Pub. Date: May 14, 2026

(54) SWITCHING BETWEEN VACUUM-PRESSURE OPERATION AND NEAR-ATMOSPHERIC-PRESSURE OPERATION IN A MATERIAL ANALYSIS SYSTEM

(71) Applicant: SPECS SURFACE NANO ANALYSIS GMBH, Berlin (DE)

(72) Inventors: Kai KUNZE, Berlin (DE); Karsten DIERSCHKE, Berlin (DE); Dietmar SCHMIDT, Berlin (DE)

(21) Appl. No.: 19/119,011

(22) PCT Filed: Oct. 4, 2023
(86) PCT No.: PCT/DE2023/100736

§ 371 Date: Apr. 7, 2025

(30) Foreign Application Priority Data
Oct. 7, 2022 (DE) 10 2022 126 029.1

(51) Int. Cl. H01J 49/24; H01J 49/00

(52) U.S. Cl. CPC H01J 49/24; H01J 49/0031

(57) ABSTRACT

The invention relates to the provision of a suitable interior for a near-atmospheric-pressure operating mode and a vacuum-pressure operating mode of an entrance portion of a material analysis system. The entrance portion comprises a housing which is designed for vacuum pressure and for near-atmospheric pressure and which has an interior that can be provided according to an operating mode of the material analysis system, which interior is designed to receive, at its distal end via an entrance opening, charged particles released by a sample. The entrance portion also comprises an interior-providing device which is designed to provide the interior in the near-atmospheric-pressure operating mode in such a way that a near-atmospheric pressure is reduced, from the distal end of the interior to the proximal end of the interior, to a vacuum pressure and to provide the interior in a vacuum-pressure operating mode in such a way that a solid angle which is assumed by the charged particles released by the sample and which extends into the interior and a distance between the sample and the distal end of the interior are greater in the vacuum-pressure operating mode than in the near-atmospheric-pressure operating mode. This allows the entrance portion to receive more electrons per unit time in different pressure environments of the entrance portion and can allow improved analysis of a sample.

### CROSS-REFERENCE TO RELATED APPLICATIONS

This application is a U.S. National Phase Application of PCT/DE 2023/100736, filed Oct. 4, 2023, which claims priority to DE 10 2022 126 029.1, filed Oct. 7, 2022, the contents of which applications are incorporated herein by reference in their entireties for all purposes.

### AREA OF THE INVENTION

The invention relates to an entrance portion of a material analysis system for charged particles released by a sample, a material analysis system for analyzing a sample comprising a corresponding entrance portion for charged particles released by the sample, a vacuum system and a method for selectively operating an entrance portion in a vacuum-pressure operating mode or a near-atmospheric-pressure operating mode, and a corresponding method for analyzing a material in the vacuum-pressure operating mode or in the near-atmospheric-pressure operating mode by means of the vacuum system. The entrance portion can be used, for example, for photoelectron spectroscopy in different pressure environments.

### PRIOR ART

Cushman et al. “Trends in Advanced XPS Instrumentation. Near-Ambient Pressure XPS” in Vac. Technol Coatings, August 2017 describes a near-ambient pressure (NAP) X-ray photoelectron spectroscopy (XPS) system that can perform photoelectron spectroscopy at pressures close to atmospheric pressure.

### DESCRIPTION OF THE INVENTION

It can be seen as an object of the invention to provide an entrance portion, a material analysis system, a vacuum system and a method for analyzing a material, which enable better analysis of samples over a wide pressure range, in particular with a higher resolution or in a shorter duration with the same resolution.

According to a first aspect of the invention, an entrance portion of a material analysis system is provided for charged particles released by a sample. The entrance portion comprises a housing configured for vacuum pressure and for near atmospheric pressure and an interior-providing device. The housing comprises an interior that can be provided depending on an operating mode of the material analysis system and is configured to receive the charged particles at its distal end via an entrance opening. The interior-providing device is configured to provide the interior in a near-atmospheric-pressure operating mode such that a near-atmospheric pressure is reduced to a vacuum pressure from the distal end of the interior to its proximal end, and to provide the interior in a vacuum-pressure operating mode such that a solid angle occupied by the charged particles released by the sample and extending into the interior and a distance between the sample and the distal end of the interior are greater in the vacuum-pressure operating mode than in the near-atmospheric-pressure operating mode.

Since the entrance portion for charged particles released by a sample comprises an interior-providing device capable of providing an interior for the vacuum pressure-operating mode and an interior for the near-atmospheric-pressure operating mode, the entrance portion can be used in the vacuum-pressure operating mode and in the near-atmospheric-pressure operating mode of a material analysis system. The entrance portion also allows switching between the vacuum-pressure operating mode and the near-atmospheric-pressure operating mode, so that a sample can be analyzed in different pressure environments and, in particular, over a wider pressure range. The entrance portion can also make it possible to achieve an intensity matched to the pressure environment and to shorten the measurement and analysis time.

Vacuum pressure is to be understood here as an absolute pressure in a pressure range between less than 10⁻¹ and 10⁻⁸ mbar. The vacuum pressure can, for example, be an absolute pressure between 10⁻³ mbar and 10⁻⁶ mbar. Near atmospheric pressure is to be understood here as pressure close to atmospheric pressure, for example as an absolute pressure between 0.1 mbar and 1000 mbar.

In the near-atmospheric-pressure operating mode, there is near-atmospheric pressure upstream of the distal end of the interior. This can be lowered to a vacuum pressure by the entrance portion, so that collision of the charged particles with gas particles in the interior of the entrance portion can be reduced. This allows a greater number of charged particles to reach the proximal end of the interior, thereby increasing a charged particle intensity measured by a detector located proximally behind the proximal end of the interior. In the vacuum-pressure operating mode, there is already a vacuum pressure upstream of the distal end of the interior. In this case, the pressure between the distal end and the proximal end of the interior does not need to be reduced, or not as much as for the near-atmospheric-pressure operating mode. This makes it possible to provide a greater solid angle, allowing more charged particles to be received via the entrance opening in the interior in vacuum-pressure operating mode. Furthermore, a greater distance from the sample can be provided, allowing easier handling and sample selection with fewer restrictions. The entrance portion allows switching between vacuum-pressure operating mode and near-atmospheric-pressure operating mode of the material analysis system.

For example, the interior-providing device may be configured to provide the interior in the near-atmospheric-pressure operating mode such that a near-atmospheric pressure of, for example, above 0.1 mbar, above 1 mbar, above 10 mbar, above 100 mbar, between 0.1 mbar and 1000 mbar, between 1 mbar and 1000 mbar, between 10 mbar and 1000 mbar or between 100 mbar and 1000 mbar in front of the distal end of the interior between its distal end and its proximal end is reduced to a vacuum pressure of, for example, below 10⁻² mbar, below 10⁻³ mbar, below 10⁻⁴ mbar, below 10⁻⁵ mbar, below 10⁻⁶ mbar, below 10⁻⁷ mbar, between 10⁻² mbar and 10⁻⁸ mbar, between 10⁻³ mbar and 10⁻⁸ mbar, between 10⁻⁴ mbar and 10⁻⁸ mbar, between 10⁻⁵ mbar and 10⁻⁸ mbar, between 10⁻⁶ mbar and 10⁻⁸ mbar or between 10⁻⁷ mbar and 10⁻⁸ mbar.

The charged particles released by the sample can be electrons or ions, for example.

The material analysis system can be a surface analysis system, for example a photoelectron spectrometer and in particular an XPS system.

The interior-providing device can be configured to provide the interior in the vacuum-pressure operating mode such that a pressure from the distal end of the interior to its proximal end at least does not increase and preferably decreases.

The entrance portion can be configured to provide the interior without changing the position of the sample. This makes it possible to switch back and forth between the operating modes without having to change the position of the sample.

A cross section of the interior in the near-atmospheric-pressure operating mode may increase along at least a pressure-reducing part of the interior in a direction from its distal end to its proximal end. This makes it possible to reduce the pressure along the pressure-reducing part, as the particles have more volume available in the direction from the distal end to the proximal end of the interior. A course of the cross section along the pressure-reducing part can, for example, increase such that an absolute pressure of 10 mbar prevailing upstream of the distal end of the interior is reduced to 10⁻⁴ mbar or 10⁻³ mbar at the proximal end.

The cross section of the interior in the vacuum-pressure operating mode may also increase at least along a pressure-reducing part of the interior in the direction from its distal end to its proximal end.

At least one part of the entrance portion can have a conical shape. In particular, the pressure-reducing part can have a conical shape. The part of the entrance portion may, for example, have a truncated cone shape or a cone-like shape. In particular, the pressure-reducing part may have a truncated cone shape or a truncated cone-like shape.

The entrance portion can comprise or be a nozzle, for example.

A cross section of the interior in the vacuum-pressure operating mode may increase from the distal end to the proximal end such that the solid angle occupied by the charged particles released by the sample and extending into the interior is between 0.1 sr and 1.47 sr, preferably between 0.21 sr and 0.84 sr. This makes it possible to receive a large number of charged particles with different properties, in particular different kinetic energies, in the entrance portion. The more charged particles are received in the entrance portion, the higher the intensity measured by a detector that detects the charged particles can be.

An entrance opening surface of the entrance opening depends on the distance and solid angle and is greater for the vacuum-pressure operating mode than for the near-atmospheric-pressure operating mode. An entrance opening surface of the entrance opening in the near-atmospheric-pressure operating mode can be between 0.0003 mm² and 1 mm², in particular between 0.07 mm² and 0.8 mm². An entrance opening surface of the entrance opening in the vacuum-pressure operating mode can be between more than 1 mm² and 1000 mm², in particular between 20 mm² and 300 mm². A distance between the sample and the distal end of the interior in the vacuum-pressure operating mode can be between 1 mm and 40 mm, in particular between 5 mm and 20 mm.

The entrance opening can comprise one or more openings. In the case of multiple openings, the opening surfaces of the openings form the entrance opening surface. If the entrance opening consists of an opening, the opening surface corresponds to the entrance opening surface. The opening or openings can be circular, elliptical, rectangular or slot-shaped, for example. The entrance openings in the near-atmospheric-pressure operating mode and in the vacuum-pressure operating mode can have an identical opening shape or a different opening shape. For example, they can be circular, elliptical, rectangular or slot-shaped. The shape can also be formed, for example, by a plurality of openings of the respective entrance opening. For example, a slit-shaped opening form of the respective entrance opening can be created by arranging a plurality of circular openings next to one another along a line with a respective distance between them, so that the openings together form a slit.

The solid angle occupied by the charged particles released by the sample and extending into the interior may be composed of a plurality of partial solid angles, wherein a partial solid angle extends through each of the openings of the plurality of openings from the location of the surface of the sample into the interior at which the charged particles are released.

For example, the entrance opening surface in the near-atmospheric-pressure operating mode can be circular with a diameter between 0.02 mm and 1 mm, for example between 0.02 mm and 0.05 mm or between 0.3 mm and 1 mm. A smaller diameter allows the near-atmospheric-pressure operating mode to be operated at a higher pressure. The smaller diameter can reduce the number of charged particles that can be received by the entrance portion. Reducing the distance between the sample and the entrance opening of the entrance portion can counteract this, as it can increase the number of charged particles received in the entrance opening. An intensity required for an analysis can be set as a function of the distance and entrance opening surface for a specific near atmospheric pressure by adjusting the distance and/or the entrance opening surface. This makes it possible to maintain a certain minimum intensity for different pressures. For example, a diameter of the entrance opening in the vacuum-pressure operating mode can be between more than 1 mm and 100 mm, preferably between 10 mm and 40 mm. For example, the diameter of the entrance opening surface in the vacuum-pressure operating mode may be equal to the distance between the sample and the distal end of the interior. The diameter of the entrance opening surface can also be between 1 and 2 times, for example 1.5 or 2 times, the distance between the sample and the distal end of the interior.

The entrance portion can comprise at least two parts that can be connected to one another. A first section may comprise the interior for the vacuum-pressure operating mode. The connected parts can form the interior for the near-atmospheric-pressure operating mode. The entrance portion can be configured such that an opening is formed between the interconnected parts along their connection point, the gas flow of which is less than the gas flow through the entrance opening, in particular 20% or less, for example 10% or less, 5% or less or 1% or less of the gas flow through the entrance opening. This makes it possible to provide a simple structure of the entrance portion that can be used to switch between the vacuum-pressure operating mode and the near-atmospheric-pressure operating mode of the material analysis system.

The connectable parts can be manufactured in such a way that the parts can be positioned very precisely in relation to one another, for example to within a few μm. The fit of the connectable parts to one another can be less than +/−10 μm, for example less than +/−5 μm or between +/−1 μm and +/−5 μm.

The interior-providing device can comprise one or more sliding mechanisms, such as sliding guides. The sliding guides can be configured to move the first part relative to the second part. For example, a first sliding guide can be configured to move the parts relative to one another in an x-direction in order to connect the parts to each other. A second sliding guide can be configured to move the parts relative to one another in a z-direction perpendicular to the x-direction, so that the parts can be pushed against each other in order to connect the parts via a seal.

The housing of the entrance portion can be made of a temperature-resistant material, for example temperature-resistant up to 100° C., up to 120° C., up to 150° C. or up to 300° C. The temperature-resistant material can be stainless steel or bronze, for example. The material can comprise a coating, for example a carbon coating. This allows the entrance portion to be baked out.

One wall of the interior can be coated, for example with graphite. The coating can be applied by means of physical vapor deposition, for example. The coating can contain carbon, for example. The coating can have a thickness of between 2 μm and 10 μm or between 5 μm and 10 μm, for example. This can make it possible to provide a conductive surface in the vicinity of the charged particles. This makes it possible to reduce charging of the surface so that the electron-optical properties of the entrance portion can be improved.

The interior-providing device can comprise one or more drives, e.g. a stepper motor, a gear drive or a pneumatic drive. The one or more drives can be configured to move the two parts relative to one another, for example, to pivot them.

The parts can each comprise a sealing part. The sealing parts may be configured to overlap one another when the parts are connected and to create a pressure-tight connection such that, in the near-atmospheric-pressure operating mode, penetration of particles between the parts does not prevent the near-atmospheric pressure from the distal end of the interior to its proximal end from being reduced to a vacuum pressure. An improved seal can be achieved by overlapping the parts in the near-atmospheric-pressure operating mode. Furthermore, when switching between the vacuum-pressure operating mode and the near-atmospheric-pressure operating mode, positioning of the parts in relation to one another can be improved.

The seal can comprise a labyrinth seal, in particular a smooth gap labyrinth seal. The parts can, for example, be sealed to one another without contact via a smooth gap labyrinth seal in the form of a long, thin gap between their surfaces that serves as a constriction. Alternatively, the seal can also comprise an O-ring. The seal can be made of fluorocarbon rubber (FKM) in accordance with DIN ISO 1629, e.g. Viton. The seal can, for example, be vulcanized onto the surfaces of the overlapping parts of the parts.

When creating the pressure-tight connection between the parts, the interior-providing device can be configured to press one part onto the other part so that at least some of the sealing parts of the parts lie directly on top of one another. This can improve the seal.

The surfaces, in particular the opposing surfaces of the parts, can be lapped, for example based on DIN 8589 T15. Lapping enables the surfaces to be smoothed and thus reduces the surface roughness. This can make it possible to create a better seal.

The interior-providing device can comprise at least one bearing via which the parts are pivotably connected to one another. The interior-providing device can be configured to pivot the parts relative to one another so that the interior is provided for the near-atmospheric-pressure operating mode or the interior is provided for the vacuum-pressure operating mode. The provision of few moving parts makes it possible to limit the degree of freedom of movement. This can reduce inaccuracies, so that in certain directions the parts can be positioned automatically due to the restriction of the degrees of freedom. This makes it possible to provide a simple and reliable entrance portion that can achieve a high positioning accuracy of the parts relative to one another. In addition, a compact entrance portion can be provided, thus enabling the provision of a compact material analysis system.

The interior-providing device can, for example, comprise two bearings, both of which are configured to pivot the parts relative to one another. The first bearing can be configured such that it can pivot one part around a first pivot axis around the other part. The second bearing can be configured such that it can pivot one part around a second pivot axis around itself. In particular, the second bearing can be configured to position one part with kinematically limited degrees of freedom on the other part.

The parts can overlap concentrically over a sealing portion. This can enable an improved seal, for example based on improved positioning accuracy of the parts relative to one another.

One or each of the two parts may comprise a hollow truncated cone. The two parts can each have an opening at their distal and proximal ends. The openings of the parts can be centered relative to one another. This makes it possible to achieve high positioning accuracy of the parts in the connected state.

The entrance portion can be a diaphragm device for receiving charged particles. The entrance portion can be connected to a lens or an analyzer. The lens can be configured to guide the charged particles from the entrance portion to the analyzer. Alternatively, the entrance portion can also be part of the lens. The entrance portion can also be configured to guide the charged particles from its distal end to its proximal end. The proximal end of the entrance portion may be connected to the lens or analyzer and deliver the charged particles to the lens or analyzer. The analyzer can be a hemispherical energy analyzer. The analyzer can be connected to a detector. Alternatively, the entrance portion can also be part of a diaphragm device, for example a front cap electrode of a diaphragm device. The diaphragm device may comprise one or more electron-optical lenses, stigmators, deflectors and/or slits.

The entrance portion can be a fold-away entrance portion or a sliding entrance portion.

The entrance portion may comprise a solid angle adjustment device. The solid angle adjustment device can be configured to adjust the solid angle. The solid angle adjustment device can comprise an entrance opening angle adjustment device which is configured to adjust an entrance opening angle. The solid angle adjustment device may comprise a distance adjustment device, which may be configured to adjust a distance between the sample and the distal end of the provided interior. Additionally or alternatively, the solid angle adjustment device may comprise an entrance opening surface adjustment device that can be used to adjust an entrance opening surface. The solid angle adjustment device allows the solid angle to be adjusted.

Alternatively or additionally, the entrance portion can comprise a diaphragm. The diaphragm can, for example, be an iris diaphragm, in particular a conical iris diaphragm. The iris diaphragm may be continuously or incrementally movable to change the entrance opening surface and the distance between the sample and the distal end of the provided interior. This makes it possible to set different entrance opening surfaces and distances between the sample and the distal end of the provided interior. This ensures, for example, sufficient intensity for an analysis under changing pressure conditions.

According to a further aspect of the invention, a material analysis system is provided which is configured to analyze a sample. The material analysis system comprises a detector for detecting charged particles released by the sample, and an entrance portion according to the invention or any embodiment of the entrance portion connected to the detector.

The material analysis system can be a photoelectron spectrometer. The photoelectron spectrometer can comprise a lens and an analyzer. The entrance portion can be part of the lens or can be connected thereto. The analyzer can be connected to the entrance portion or the lens. The analyzer can be a hemispherical energy analyzer. The analyzer can be connected to the detector. The material analysis system can be a surface analysis system for analyzing surface and/or material properties.

According to a further aspect of the invention, a vacuum system is provided. The vacuum system comprises: a vacuum housing configured for vacuum pressure and near atmospheric pressure for hermetically enclosing a cavity for arranging a sample, an illumination system for illuminating the sample, and a material analysis system according to the invention or any embodiment of the material analysis system for analyzing the sample. The vacuum system can make it possible to analyze samples at different pressures with the material analysis system. The illumination system can be an X-ray radiation source, for example an X-ray radiation source for illuminating the sample with monochromatic X-rays. The illumination system can contain a monochromator configured to monochromatize X-ray radiation. The monochromator can be positioned between the X-ray radiation source and the sample in order to be able to emit monochromatic X-ray radiation onto the sample. This enables the sample to be illuminated with monochromatic X-rays and photoelectrons to be extracted from the sample. The vacuum system can be used, for example, to generate X-ray photoemission spectra and analyze the sample based on them.

The vacuum system can contain a sample holder and/or a sample tray. The sample holder or the sample tray can be movable and/or pivotable. The sample holder or sample tray can be part of the material analysis system.

According to a further aspect of the invention, there is provided a method for selectively operating an entrance portion according to the invention or any embodiment of the entrance portion in a vacuum-pressure operating mode or a near-atmospheric-pressure operating mode. The method comprises the following steps:
selecting the near-atmospheric-pressure operating mode or the vacuum-pressure operating mode, and
providing the interior depending on the selected operating mode, such that the interior is provided in the near-atmospheric-pressure operating mode such that a near-atmospheric pressure from the distal end of the interior to its proximal end is reduced to a vacuum pressure, and the interior is provided in the vacuum-pressure operating mode such that a solid angle occupied by the charged particles released by the sample and extending into the interior and a distance between the sample and the distal end of the interior is greater in the vacuum-pressure operating mode than in the near-atmospheric-pressure operating mode.

Selecting the near-atmospheric-pressure operating mode or the vacuum-pressure operating mode can be done manually, for example by a user, or automatically, for example based on a pressure measurement upstream of the distal end of the interior. For this purpose, the entrance portion can comprise a pressure sensor. Alternatively, a pressure sensor can also be provided in the vacuum system. Depending on the pressure upstream of the distal end of the interior, a corresponding interior can be provided to ensure operation at a sufficient intensity. This can enable improved and more reliable operation under different pressure conditions. In addition, samples can be analyzed at different pressures; in particular, it is possible to analyze how the different pressures affect the sample and its properties.

According to another aspect of the invention, there is provided a method for selectively analyzing a material in a vacuum-pressure operating mode or a near-atmospheric-pressure operating mode by means of a vacuum system according to the invention or any embodiment of the vacuum system. The method comprises the following steps:
providing a sample in the vacuum housing of the vacuum system,
operating the entrance portion according to the method of the invention,
adjusting the pressure upstream of the distal end of the interior of the entrance portion depending on the operating mode, so that in the near-atmospheric-pressure operating mode, near-atmospheric pressure prevails upstream of the distal end of the interior and in the vacuum-pressure operating mode, vacuum pressure prevails upstream of the distal end of the interior,
illuminating the sample with the illumination system, and
detecting charged particles released by the sample in the detector.

The charged particles can be detected in the detector with energy resolution. For this purpose, an analyzer, preferably an energy analyzer, in particular a hemispherical energy analyzer, can be arranged in front of the detector and can be connected thereto.

For example, the method may include a step for adjusting the distance of the entrance opening to the sample to 1 to 2 times, preferably 1.5 times, the entrance opening surface of the entrance opening.

According to a further aspect of the invention, a use of the vacuum system according to the invention or any embodiment of the vacuum system is for: a surface analysis, a measurement of a surface reaction, a measurement of liquid-solid reactions, a measurement of liquid-gas reactions, a measurement of liquids, a measurement of thin layers, a detection of foreign substances in liquids, a photoemission measurement, a photoelectron spectroscopy measurement close to atmospheric pressure, an X-ray photoelectron spectroscopy measurement close to atmospheric pressure, an electrochemical measurement, a battery analysis, an oxidation measurement, an electrolyte measurement, an electrode measurement, a sample measurement through a liquid, a quality control, a corrosion measurement, a catalyst measurement, a pressure-dependent measurement, a measurement of a biological sample, a potentiometry measurement, a measurement of a supersaturated liquid, or an analysis of microelectronic devices.

According to a further aspect of the invention, a use of the method according to the invention or any embodiment of the method is for: a surface analysis, a measurement of a surface reaction, a measurement of liquid-solid reactions, a measurement of liquid-gas reactions, a measurement of liquids, a measurement of thin layers, a detection of foreign substances in liquids, a photoemission measurement, a photoelectron spectroscopy measurement close to atmospheric pressure, an X-ray photoelectron spectroscopy measurement close to atmospheric pressure, an electrochemical measurement, a battery analysis, an oxidation measurement, an electrolyte measurement, an electrode measurement, a sample measurement through a liquid, a quality control, a corrosion measurement, a catalyst measurement, a pressure-dependent measurement, a measurement of a biological sample, a potentiometry measurement, a measurement of a supersaturated liquid, or an analysis of microelectronic devices.

According to a further aspect of the invention, there is provided a computer program product for selectively operating an entrance portion according to the invention in a vacuum-pressure operating mode or a near-atmospheric-pressure operating mode. The computer program product includes computer program code means for causing a processor to execute the method according to the invention or any embodiment of the method when the computer program product is executed on the processor.

According to a further aspect, there is provided a computer-readable medium having stored thereon the computer program product for selectively operating the entrance portion. Alternatively, or additionally, the computer-readable medium may have stored the computer program product according to one or more embodiments of the computer program product.

According to a further aspect of the invention, there is provided a computer program product for selectively analyzing a material in a vacuum-pressure operating mode or a near-atmospheric-pressure operating mode by means of a vacuum system according to the invention or any embodiment of the vacuum system. The computer program product includes computer program code means for causing a processor to execute the method according to the invention or any embodiment of the method when the computer program product is executed on the processor.

According to a further aspect, a computer-readable medium is provided having stored thereon the computer program product for selectively analyzing the material. Alternatively, or additionally, the computer-readable medium may have stored the computer program product according to one or more embodiments of the computer program product.

The entrance portion according to the invention, the material analysis system according to the invention, the vacuum system according to the invention, the methods according to the invention and the uses according to the invention, as well as the computer program products and computer readable media may have similar and/or identical preferred embodiments as defined in particular in the dependent claims.

Furthermore, a preferred embodiment of the invention may also be any combination of the features of the dependent claims or of the aforementioned embodiments in conjunction with the corresponding independent claim.

These and other aspects of the invention are explained in more detail below with reference to embodiments shown in the figures.

### BRIEF DESCRIPTION OF THE FIGURES

In the following figures:

FIG. 1A schematically and exemplarily shows a first embodiment of the entrance portion in the form of a fold-away nozzle arrangement in a near-atmospheric-pressure operating mode;

FIG. 1B schematically and exemplarily shows the first embodiment during the folding away process;

FIG. 1C schematically and exemplarily shows the first embodiment in a vacuum-pressure operating mode;

FIG. 2A schematically and exemplarily shows an embodiment of a vacuum system with a material analysis system in the form of a photoelectron spectrometer in the vacuum-pressure operating mode containing a second embodiment of an entrance portion;

FIG. 2B schematically and exemplarily shows the embodiment of the vacuum system in the near-atmospheric-pressure operating mode;

FIG. 3A schematically and exemplarily shows a third embodiment of the entrance portion in the form of a displaceable nozzle in the near-atmospheric-pressure operating mode;

FIG. 3B schematically and exemplarily shows a third embodiment of the entrance portion in the form of a displaceable nozzle in the vacuum-pressure operating mode;

FIG. 4A schematically and exemplarily shows a fourth embodiment of the entrance portion in a sectional drawing in the near-atmospheric-pressure operating mode;

FIG. 4B schematically and exemplarily shows a fourth embodiment of the entrance portion in the vacuum-pressure operating mode;

FIG. 5 is an exemplary flow chart of an embodiment of the method for selectively operating the entrance portion in the vacuum-pressure operating mode or in the near-atmospheric-pressure operating mode;

FIG. 6 is an exemplary flow chart of an embodiment of a method for selectively analyzing a material in the vacuum-pressure operating mode or in the near-atmospheric-pressure operating mode by means of a vacuum system.

### DESCRIPTION OF THE EMBODIMENTS

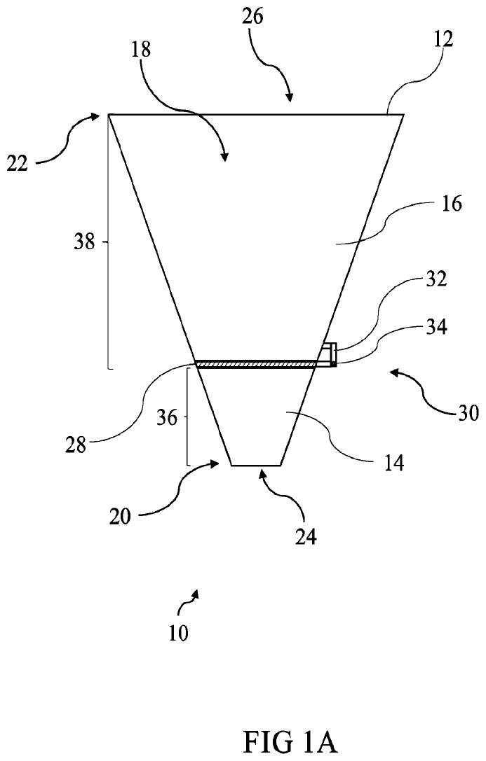

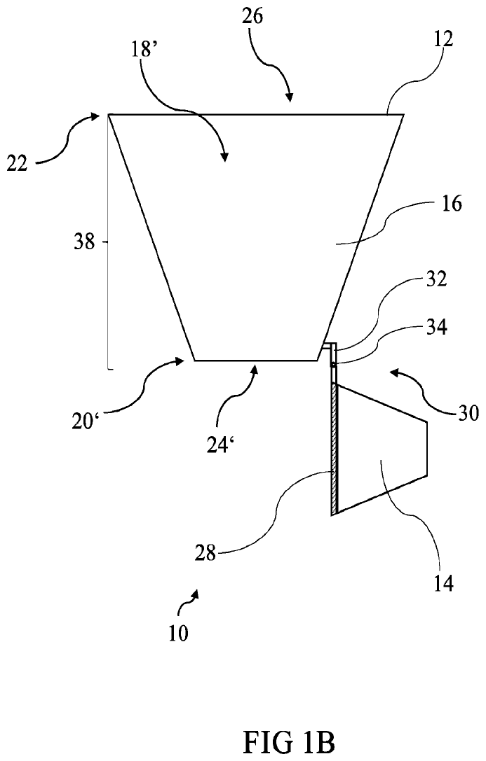

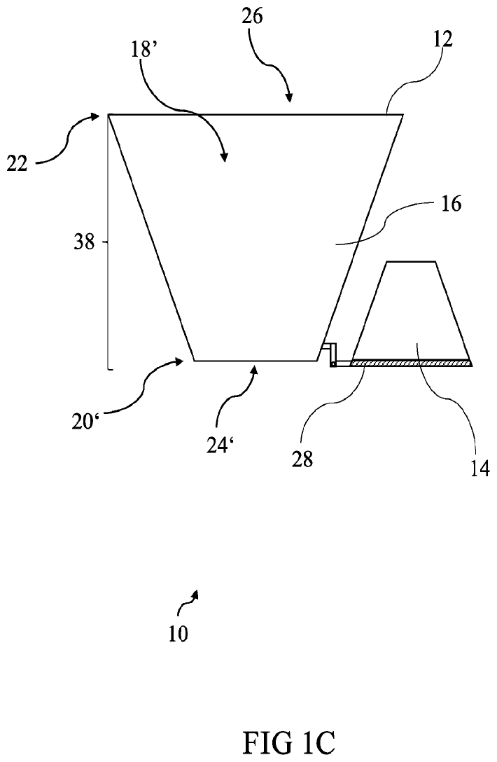

FIG. 1A shows a first embodiment of an entrance portion 10 of a material analysis system. In this embodiment, the material analysis system is a photoelectron spectrometer that receives photoelectrons from a sample and generates energy-resolved photoemission spectra. The photoemission spectra can be used for material analysis. In the first embodiment, the entrance portion 10 is a fold-away nozzle arrangement. The entrance portion 10 is configured to receive the photoelectrons released by the sample. In other embodiments, the entrance portion may also be configured to receive other types of charged particles released by the sample, such as ions. The entrance portion 10 can be operated in a near-atmospheric-pressure operating mode (see FIG. 1A) or in a vacuum-pressure operating mode (see FIG. 1C).

The entrance portion 10 comprises a housing 12 that is configured to withstand vacuum pressure and near-atmospheric pressure. In the first embodiment, the housing 12 is formed by the two parts 14 and 16 which can be connected to one another in a pressure-tight manner and which enclose an interior 18 extending from its distal end 20 to its proximal end 22. During operation of the photoelectron spectrometer, the distal end 20 is aligned in the direction of the sample (not shown). During operation, the proximal end 22 is aligned in the direction of an energy analyzer (not shown). At the distal end 20, there is an entrance opening 24 into the interior 18, which receives the photoelectrons. At the proximal end 22, there is an exit opening 26 which guides the photoelectrons out of the entrance portion 10. Between the interconnectable parts 14 and 16 there is a seal 28 in the form of an O-ring. The interior 18 can be adjusted via an interior-providing device 30 with a drive 32 and a bearing in the form of a radial bearing 34 driven by the drive 32. For this purpose, the part 14 can be folded away around the radial bearing 34, as shown in FIG. 1B, so that the provided interior 18′ now extends only from the distal end 20′ to the proximal end 22. Part 16 thus forms the interior 18′ for the vacuum-pressure operating mode and the connected parts 14 and 16 form the interior 18 for the near-atmospheric-pressure operating mode. Part 14 can be folded away such that it does not obstruct the operation of the entrance portion 10. For this purpose, part 14 is folded further away from the entrance opening 24′, as shown in FIG. 1C. The entrance portion 10 can be operated in the vacuum-pressure operating mode as shown in FIG. 1C. Part 14 can also be folded away such that the position of the sample does not have to be changed for the folding away process (not shown).

The interior-providing device 30 makes it possible to provide an interior 18 or 18′ depending on the operating mode of the material analysis system. In other embodiments, the interior-providing device can also comprise a plurality of bearings via which the parts are pivotably connected to one another and can be configured to pivot the parts relative to one another such that the interior is provided for the near-atmospheric-pressure operating mode or the interior is provided for the vacuum-pressure operating mode. The interior-providing device 30 provides the interior 18 in the near-atmospheric-pressure operating mode such that a near-atmospheric pressure from the distal end 20 to the proximal end 22 is reduced to a vacuum pressure. For this purpose, the cross section of the interior 18 increases along a pressure-reducing part 36 in the direction from its distal end 20 to its proximal end 22. By reducing the pressure between distal end 20 and proximal end 22, the mean free path of the photoelectrons is increased, so that more photoelectrons can reach the proximal end 22 without colliding with gas molecules. In the near-atmospheric-pressure operating mode, for example, an absolute pressure of 100 mbar prevails upstream of the distal end 20 and a vacuum pressure, for example an absolute pressure of approximately 10⁻³ mbar, prevails at the proximal end 22. The absolute pressure can then be further reduced by additional vacuum pumps up to the energy analyzer, for example to 10⁻⁶ mbar. The absolute pressure upstream of the distal end 20 can also be between 0.1 mbar and 1000 mbar in the near-atmospheric-pressure operating mode.

In vacuum-pressure operating mode, for example, a pressure of between 10⁻¹ mbar and 10⁻⁸ mbar, e.g. between 10⁻³ mbar and 10⁻⁶ mbar, prevails upstream of the distal end 20′. The interior-providing device 30 provides the interior 18′ in the vacuum-pressure operating mode such that a solid angle occupied by the photoelectrons released by the sample and extending into the interior 18′ is greater than a solid angle occupied by the photoelectrons released by the sample and extending into the interior 18 (not shown). In this case, the solid angle is 0.84 sr for the vacuum-pressure operating mode and 0.46 sr for the near-atmospheric-pressure operating mode. Moreover, in this case, an entrance opening surface of the entrance opening 24′ of the interior 18′ is also greater than an entrance opening surface of the entrance opening 24 of the interior 18. In addition, a distance between the sample and the distal end 20′ of the interior 18′ is greater than a distance between the sample and the distal end 20 of the interior 18 (not shown). In this embodiment, a cross section of the interior 18′ also increases in the vacuum-pressure operating mode from the distal end 20′ to the proximal end 22 such that the interior 18′ can receive a solid angle of 0.84 sr in the vacuum-pressure operating mode. This corresponds to a cone with a half angle of 30° of the photoelectrons released by the sample during operation of the photoelectron spectrometer. In other embodiments, the cross section of the interior in the vacuum-pressure operating mode may also increase from the distal end to the proximal end such that the solid angle occupied by the charged particles released by the sample and extending into the interior is between 0.1 sr and 1.47 sr. This corresponds to a cone with a half angle between 10° and 40° of the charged particles released by the sample. In further embodiments, a cone with a half angle for example between 0.1° and 40°, between 3° and 40° or between 20° and 40° of the charged particles released by the sample can be received by the interior.

In this embodiment, the cross section of the interior 18 in the near-atmospheric-pressure operating mode also increases from the distal end 20 to the proximal end 22 such that the interior 18 can receive a solid angle of 0.46 sr in the near-atmospheric-pressure operating mode.

In this embodiment, in the near-atmospheric-pressure operating mode, the entrance opening shape of the entrance opening 24 is circular and has an entrance opening surface of 0.1 mm². In other embodiments, the entrance opening shape can also have a different shape, for example rectangular, oval or another shape. In addition, in the near-atmospheric-pressure operating mode, the entrance opening surface can also have a different size, for example between 0.0003 mm² and 1 mm², e.g. between 0.03 mm² and 0.8 mm², in particular between 0.07 mm² and 0.8 mm² in size.

In this embodiment, in the vacuum-pressure operating mode, the entrance opening of the entrance opening 24′ is circular and has an entrance opening surface of 100 mm². In other embodiments, the entrance opening shape can also have a different shape, for example rectangular, oval or another shape. In addition, in the vacuum-pressure operating mode, the entrance opening surface can also have a different size, for example between more than 1 mm² and 1000 mm², in particular between 20 mm² and 300 mm² in size.

In this embodiment, in the vacuum-pressure operating mode, a distance between the sample and the distal end 20′ of the interior 18′ is 10 mm in size. In other embodiments, in the vacuum-pressure operating mode, the distance between the sample and the distal end 20′ of the interior 18′ may be between 1 mm and 40 mm, in particular between 5 mm and 20 mm.

In the following embodiments, the same reference signs are used for the same features. The features are not explained again in places where this is not necessary for understanding.

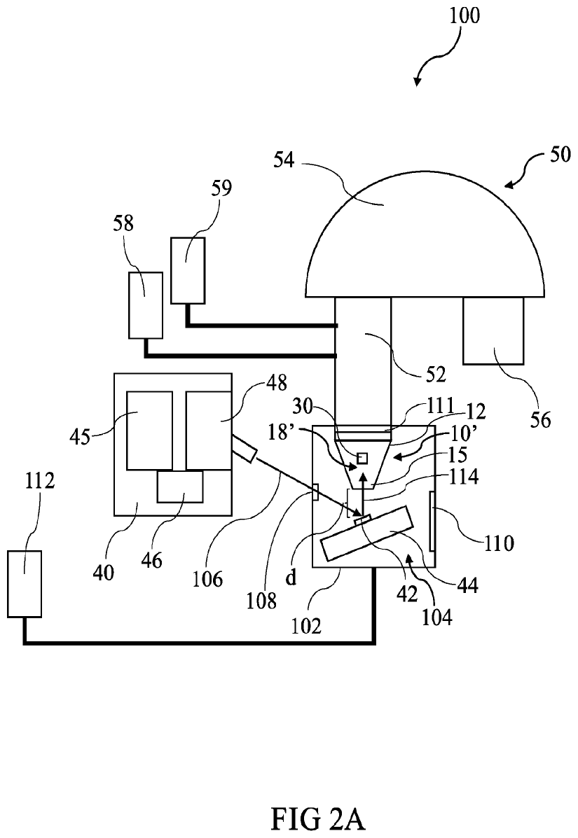

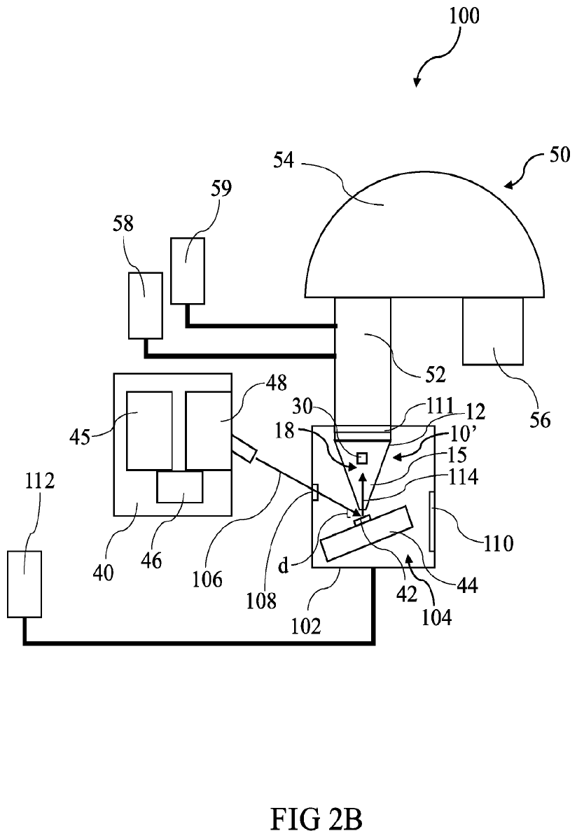

FIG. 2A shows an embodiment of a vacuum system 100. The vacuum system 100 can be used, for example, for a surface analysis, a measurement of a surface reaction, a measurement of liquid-solid reactions, a measurement of liquid-gas reactions, a measurement of liquids, a measurement of thin layers, a detection of foreign substances in liquids, a photoemission measurement, a photoelectron spectroscopy measurement close to atmospheric pressure, an X-ray photoelectron spectroscopy measurement close to atmospheric pressure, an electrochemical measurement, a battery analysis, an oxidation measurement, an electrolyte measurement, an electrode measurement, a sample measurement through a liquid, a quality control, a corrosion measurement, a catalyst measurement, a pressure-dependent measurement, a measurement of a biological sample, a potentiometry measurement, a measurement of a supersaturated liquid or an analysis of microelectronic devices.

The vacuum system 100 includes a vacuum housing 102 configured for vacuum pressure and near atmospheric pressure, an illumination system 40 for illuminating a sample 42, and a material analysis system in the form of a photoelectron spectrometer 50 for analyzing the sample 42.

The vacuum housing 102 hermetically encloses a cavity 104. The vacuum housing 102 comprises a window 108 transparent to X-ray radiation and a hermetically sealable transfer opening 110 for arranging the sample 40 on a sample holder 44 arranged in the cavity 104, as well as a connection opening 111 for connecting to the photoelectron spectrometer 50. In this case, the sample holder 44 is a tiltable and movable platform for arranging the sample 42 under the photoelectron spectrometer 50. The cavity 104 is set to a predetermined absolute pressure by a vacuum pump 112.

The illumination system 40 includes an electron gun 45, a target anode 46 and an X-ray monochromator 48. The illumination system 40 generates X-ray radiation by firing electrons from the electron gun 45 at the target anode 46. The target anode 46 is made of a material, for example Al, Ag or Cr, which generates a characteristic X-ray radiation with a predetermined energy. The X-ray monochromator 48 generates the monochromatic X-ray radiation 106 from the X-ray radiation. The sample 42 is illuminated with the monochromatic X-ray radiation 106 to excite photoelectrons 114. The photoelectrons 114 are released by the sample 42 and received by the photoelectron spectrometer 50.

The photoelectron spectrometer 50 includes a second embodiment of an entrance portion 10′ comprising a conical iris diaphragm 15, an electron-optical lens 52, an analyzer 54 in the form of a hemispherical energy analyzer, and a detector 56 in the form of a CMOS detector. In other embodiments, any other embodiment of the entrance portion may be used in conjunction with the material analysis system and/or in the vacuum system.

The detector 56 is connected to the entrance portion 10′ via the lens 52 and the analyzer 54 and can detect the photoelectrons released by the sample 42. In other embodiments, the detector may also be configured to detect other types of charged particles released by the sample.

In this embodiment, the conical iris diaphragm 15 of the entrance portion 10′ is formed by a thin metallic film. The film has a wall thickness of 5 μm. In other embodiments, the wall thickness can also be between 1 μm and 50 μm, for example. The film is suspended in a housing 12 of the entrance portion 10′ and rolled up into a funnel shape, so that displacing the film at one or more points of application of the film by an interior-providing device 30 changes the distance d between the sample 42 and the distal end of the interior 18′ (see FIG. 2A) or 18 (see FIG. 2B). In addition, this also changes the entrance shape, the solid angle occupied by the photoelectrons 114 released by the sample 42 and extending into the interior 18′ or 18, and the entrance opening surface of the entrance opening of the entrance portion 10′. The entrance shape can vary between a round and elliptical shape. If the distance d is increased, the entrance opening surface and the solid angle are also increased. Thus, the interior-providing device 30 makes it possible to provide the interior 18 for the near-atmospheric-pressure operating mode (see FIG. 2B) and the interior 18′ for the vacuum-pressure operating mode (see FIG. 2A).

In this embodiment, the lens 52 has a plurality of pressure stages in which the absolute pressure is successively reduced. For this purpose, the vacuum pumps 58 and 59 are provided, which pump out the interior of the pressure stages of lens 52. This makes it possible to further reduce the pressure upstream of the analyzer 54. The lens 52 serves to guide the photoelectrons 114 from the proximal end of the entrance portion 10′ to the analyzer 54. In other embodiments, the entrance portion 10′ may also be a part of the lens.

In the analyzer 54, the photoelectrons 114 are spatially separated based on their kinetic energy and guided to the detector 56.

The detector 56 receives and detects the photoelectrons 114 and can thus generate an energy-resolved photoelectron emission spectrum of the sample 42 in order to analyze it. In this embodiment, an absolute pressure of 10⁻⁶ mbar is upstream of the detector 56. For this purpose, in addition to the vacuum pumps 58 and 59, further vacuum pumps can be provided in the material analysis system (not shown). In other embodiments, a different vacuum pressure can also be set.

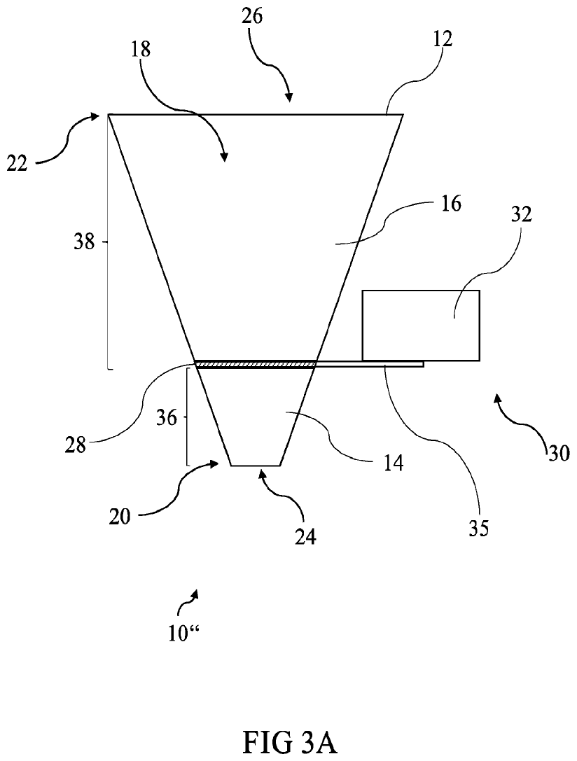

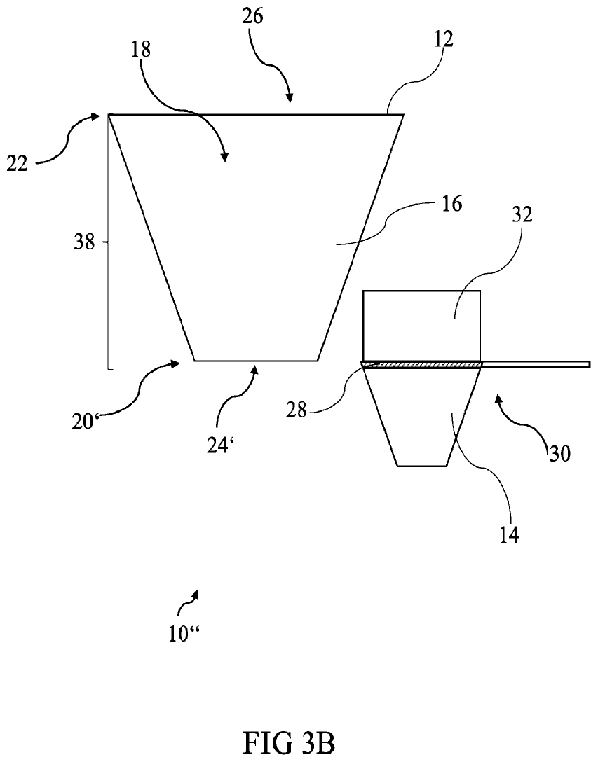

FIG. 3A and FIG. 3B show a third embodiment of the entrance portion 10″ in the form of a displaceable nozzle. In contrast to the first embodiment, the nozzle in the third embodiment is not folded away, but moved linearly. For this purpose, the interior-providing device 30 comprises a sliding guide 35 driven by a drive 32, which can move the part 14 of the entrance portion 10″ between a position connected to the part 16 for the near-atmospheric-pressure operating mode (see FIG. 3A) and a position disconnected from the part 16 for the vacuum-pressure operating mode (see FIG. 3B).

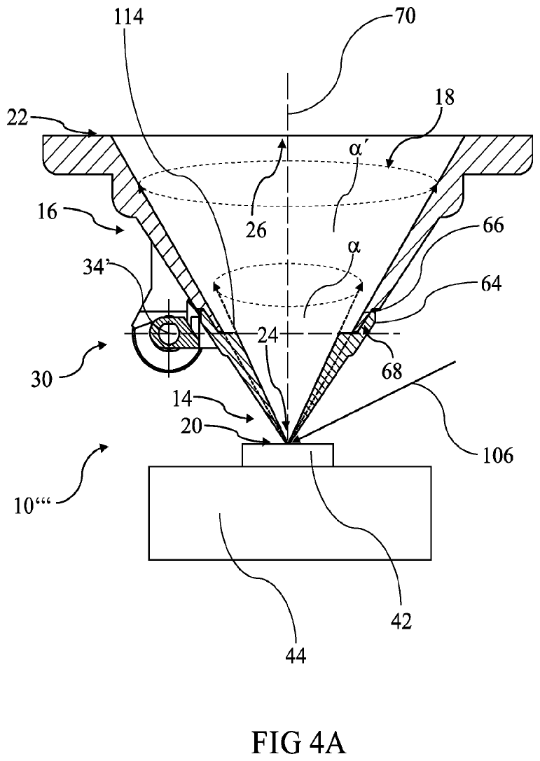

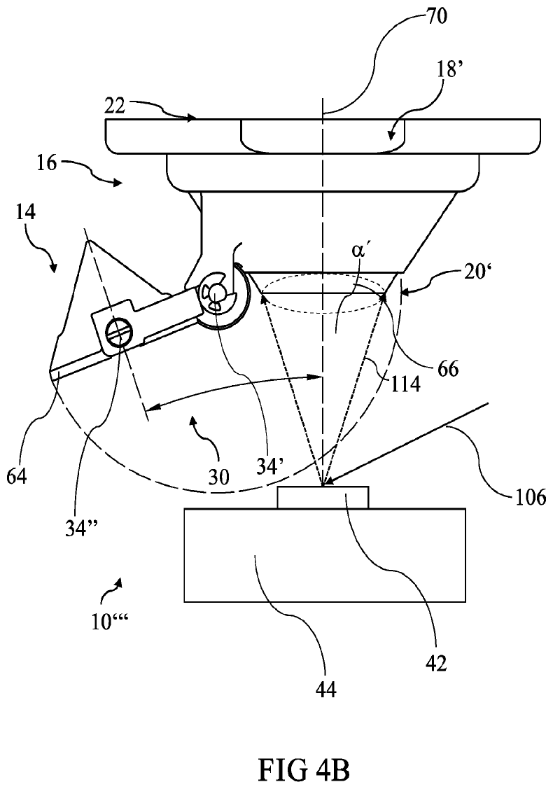

FIG. 4A shows a fourth embodiment of the entrance portion 10′″ in a sectional drawing in the near-atmospheric-pressure operating mode. The fourth embodiment of the entrance portion 10′″ is similar to the first embodiment of the entrance portion 10. In contrast to the first embodiment of the entrance portion 10, however, the fourth embodiment of the entrance portion 10′″ comprises, among other things, a gap seal between the parts 14 and 16 instead of an O-ring.

The parts 14 and 16 each comprise a sealing part 64 and 66 respectively. The sealing parts 64 and 66 overlap with each other when the parts 14 and 16 are in a connected state, so that a pressure-tight connection is created such that in the near-atmospheric-pressure operating mode, penetration of particles, in particular gas particles between the parts 14 and 16 does not prevent the reduction of the near-atmospheric pressure from the distal end 20 of the interior 18 to its proximal end 22 to a vacuum pressure. In this embodiment, a gas flow rate through the sealing parts 64 and 66 is less than 5% of the gas flow rate through the entrance opening 24. In other embodiments, a different seal tightness may be achieved by the seal parts 64 and 66, such as a lower seal tightness, e.g., with a gas flow rate of up to 20% of the gas flow rate through the entrance opening, or a higher seal tightness, e.g., with a gas flow rate of less than 1% of the gas flow rate through the entrance opening.

In the fourth embodiment of the entrance portion 10″, the interior-providing device 30 comprises two radial bearings 34′ and 34″ (see FIG. 4B). The part 14 can be pivoted about the first radial bearing 34′, around the part 16. The second radial bearing 34″ enables the part 14 to be pivoted about an additional axis in order to create an improved pressure-tight connection between the parts 14 and 16. For this purpose, the interior-providing device 30 can press the part 14 onto the other part 16 when establishing the pressure-tight connection between the parts 14 and 16, so that a part of the sealing parts 64 and 66 of the parts 14 and 16 lie directly on top of each other. In addition, in this embodiment, the parts 14 and 16 overlap concentrically via a sealing portion 68 (see FIG. 4A).

Like the other embodiments, the fourth embodiment of the entrance portion 10′″ can also be operated in the near-atmospheric-pressure operating mode (see FIG. 4A) and in the vacuum-pressure operating mode (see FIG. 4B). The solid angle α′ occupied by the photoelectrons 114 released by the sample 42 and extending into the interior 18′ in the vacuum-pressure operating mode is greater than the solid angle α occupied by the photoelectrons 114 released by the sample 42 and extending into the interior 18 in the near-atmospheric-pressure operating mode.

The distal end 20 or 20′ is located in the vicinity of the sample 42 arranged on the sample holder 44. Preferably, the sample 42 is located at a distance between 1 and 2 times the diameter of the circular entrance opening. In this embodiment, the sample is centered with respect to an optical axis 70 of the entrance portion 10′″. The optical axis 70 is identical to the optical axis of a lens (not shown) arranged at the proximal end 22 of the entrance portion 10′″, which guides photoelectrons 114 to an analyzer. The analyzer in turn guides the photoelectrons to a detector in an energy-resolved manner so that they can be detected in an energy-resolved manner.

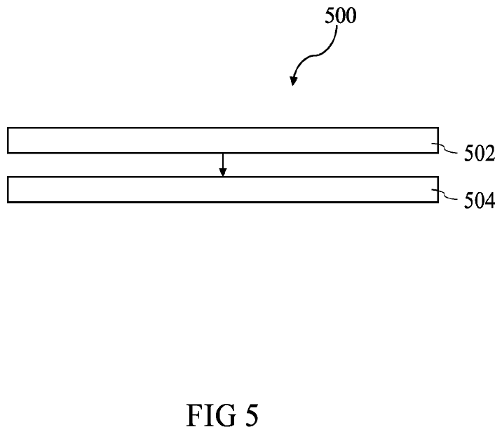

FIG. 5 shows an embodiment of the method 500 for selectively operating an entrance portion, for example one of the embodiments of the entrance portion of FIGS. 1 to 4, in the vacuum-pressure operating mode or in the near-atmospheric-pressure operating mode.

In step 502, the near-atmospheric-pressure operating mode or the vacuum-pressure operating mode is selected. For example, the operating mode can be selected automatically or manually by a user based on a pressure measurement before the distal end of the interior of the entrance portion.

In step 504, the interior is provided depending on the selected operating mode. If the near-atmospheric-pressure operating mode has been selected, the interior is provided so that a near-atmospheric pressure from the distal end of the interior to its proximal end is reduced to a vacuum pressure. If the vacuum-pressure operating mode has been selected, the interior is provided with a greater solid angle occupied by the charged particles released by the sample extending into the interior and a greater distance between the sample and the distal end of the interior than in the near-atmospheric-pressure operation mode. In addition, the entrance opening surface of the entrance opening is also greater. Depending on the type of entrance portion, the interior can be provided in different ways. For example, two interconnected parts can be folded apart by folding one part away. This can increase the entrance opening surface and at the same time increase the distance between the sample and the distal end of the now provided interior.

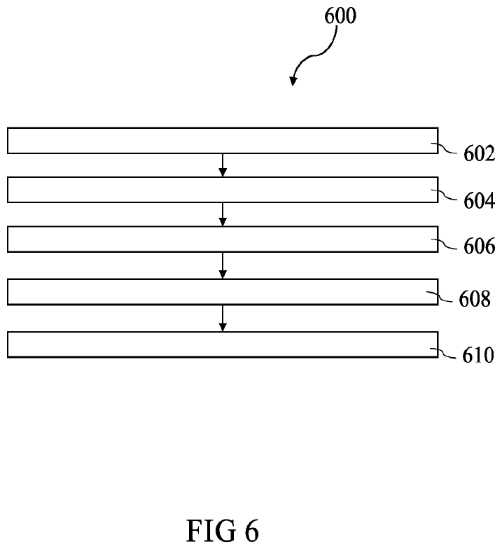

FIG. 6 shows an embodiment of a method 600 for selectively analyzing a material in the vacuum-pressure operating mode or in the near-atmospheric-pressure operating mode using a vacuum system, for example the vacuum system shown in FIGS. 2A and 2B.

In step 602, a sample is provided in the vacuum housing of the vacuum system.

In step 604, the entrance portion of the vacuum system is operated according to the method 500. First, the near-atmospheric-pressure operating mode or the vacuum-pressure operating mode is selected in step 502 and then the interior is provided in step 504 depending on the selected operating mode.

In step 606, the pressure upstream of the distal end of the interior of the entrance portion is set as a function of the operating mode. For this purpose, the pressure in the vacuum housing can be set, for example. Alternatively, the pressure can also be set locally in the area of the sample. The pressure is set so that in the near-atmospheric-pressure operating mode, near-atmospheric pressure prevails upstream of the distal end of the interior, and in the vacuum-pressure operating mode, vacuum pressure prevails upstream of the distal end of the interior. Steps 604 and 606 can also be carried out in reverse order. For example, if the operating mode is automatically selected, e.g., based on a pressure measurement, the pressure may be set first in step 606 so that the operating mode is then automatically selected in step 502.

In step 608, the sample is illuminated with the illumination system. For this purpose, monochromatic X-ray radiation of a specific wavelength or energy can be irradiated onto the surface of the sample, for example.

In step 610, the charged particles released by the sample are detected in the detector. For example, photoelectrons emitted from the sample, excited by monochromatic X-ray radiation, can be detected in the detector. Before the photoelectrons are detected, they can be passed through an energy analyzer, for example in the form of a hemispherical energy analyzer, in order to resolve their kinetic energy.

The method for selectively analyzing can be used, for example, for a surface analysis, a measurement of a surface reaction, a measurement of liquid-solid reactions, a measurement of liquid-gas reactions, a measurement of liquids, a measurement of thin layers, a detection of foreign substances in liquids, a photoemission measurement, a photoelectron spectroscopy measurement close to atmospheric pressure, an X-ray photoelectron spectroscopy measurement close to atmospheric pressure, an electrochemical measurement, a battery analysis, an oxidation measurement, an electrolyte measurement, an electrode measurement, a sample measurement through a liquid, a quality control, a corrosion measurement, a catalyst measurement, a pressure-dependent measurement, a measurement of a biological sample, a potentiometry measurement, a measurement of a supersaturated liquid or an analysis of microelectronic devices.

The description of the invention given above in conjunction with the drawings serves to explain the features of the invention in the form of embodiments. However, the features explained in the embodiments are only given by way of example and should not be understood as limiting. In particular, the invention is not limited to the embodiments or the combination of features of individual embodiments. For example, it is also possible to operate the invention in one embodiment with another material analysis system that analyzes, for example, other charged particles such as ions.

Other variants and variations of the embodiments shown can be understood and implemented by the person skilled in the art by reproducing the claimed invention in view of the figures, description and claims.

The words “containing,” “having,” “comprising,”, “including”, do not exclude further elements, components or steps, and the indefinite articles “a” or “an” do not exclude a plurality.

For example, a unit, processor or apparatus may perform a variety of functions of various items mentioned in the claims. The fact that particular means are mentioned in different claims should not be understood to mean that a combination of these means cannot be used advantageously.

Method steps such as selecting the near-atmospheric-pressure operating mode or the vacuum-pressure operating mode, providing the interior depending on the selected operating mode, etc., which are carried out by one or more units, components or devices, can also be carried out by another number of units, components or devices. These method steps and/or the method may be implemented or provided, for example, as computer program code or computer program code means and/or as specific hardware.

A computer program product may be stored or provided on a suitable medium, such as an optical storage medium or a solid state medium. It may also be provided together with or as part of other hardware. It may also be provided in other ways, such as via the internet, Ethernet, or other wired or wireless telecommunications system.

The reference symbols used in the claims are not to be understood as limiting the features of the embodiments, but merely as exemplary for the features of the claims.

The invention relates to providing a suitable interior for a near-atmospheric-pressure operating mode and a vacuum-pressure operating mode of an entrance portion of a material analysis system. The entrance portion comprises a housing configured for vacuum pressure and near atmospheric pressure with an interior which can be provided depending on an operating mode of the material analysis system and which is configured to receive charged particles released by a sample at its distal end via an entrance opening. In addition, the entrance portion comprises an interior-providing device configured to provide the interior in the near-atmospheric-pressure operating mode such that a near-atmospheric pressure from the distal end of the interior to the its proximal end is reduced to a vacuum pressure, and to provide the interior in a vacuum-pressure operating mode such that a solid angle occupied by charged particles released by the sample and extending into the interior and a distance between the sample and the distal end of the interior are greater in the vacuum-pressure operating mode than in the near-atmospheric-pressure operating mode. This allows the entrance portion to receive more electrons per unit time at different pressure environments of the entrance portion and can allow for improved analysis of a sample.

1. An entrance portion of a material analysis system for charged particles released by a sample, the entrance portion comprising:
a housing configured for vacuum pressure and near-atmospheric pressure with an interior which can be provided depending on an operating mode of the material analysis system and which is configured to receive the charged particles at its distal end via an entrance opening, and
an interior-providing device which is configured
to provide the interior in a near-atmospheric-pressure operating mode such that a near-atmospheric pressure is reduced to a vacuum pressure from the distal end of the interior to its proximal end, and
to provide the interior in a vacuum-pressure operating mode such that a solid angle occupied by the charged particles released by the sample and extending into the interior and a distance between the sample and the distal end of the interior are greater in the vacuum-pressure operating mode than in the near-atmospheric-pressure operating mode.

2. The entrance portion according to claim 1, wherein a cross section of the interior increases in the near-atmospheric-pressure operating mode at least along a pressure-reducing part of the interior in a direction from its distal end to its proximal end.

3. The entrance portion according to claim 1, wherein a cross section of the interior in the vacuum-pressure operating mode increases from the distal end to the proximal end such that the solid angle occupied by the charged particles released by the sample and extending into the interior is between 0.1 sr and 1.47 sr.

4. The entrance portion according to claim 1, wherein an entrance opening surface of the entrance opening in the near-atmospheric-pressure operating mode is from 0.0003 mm² to 1 mm², an entrance opening surface of the entrance opening in the vacuum-pressure operating mode is more than 1 mm² and up to 1000 mm², and a distance between the sample and the distal end of the interior in the vacuum-pressure operating mode is from 1 mm to 40 mm.

5. The entrance portion according to claim 1, wherein the entrance portion comprises at least two parts connectable to one another to provide connected parts, wherein a first part comprises the interior for the vacuum-pressure operating mode and the connected parts form the interior for the near-atmospheric-pressure operating mode.

6. The entrance portion according to claim 5, wherein the at least two parts each comprise a sealing part configured to overlap with one another in the connected state of the parts and to create a pressure-tight connection such that, in the near-atmospheric-pressure operating mode, penetration of particles between the at least two parts does not prevent a reduction of the near-atmospheric pressure from the distal end of the interior to its proximal end to a vacuum pressure.

7. The entrance portion according to claim 6, wherein the interior-providing device is configured, when establishing the pressure-tight connection between the at least two parts, to press one part onto the other part, so that at least some of the sealing parts of the at least two parts lie directly on top of one another.

8. The entrance portion according to claim 5, wherein the interior-providing device comprises at least one bearing, via which the at least two parts are pivotably connected to one another, and wherein the interior-providing device is configured to pivot the parts relative to one another such that the interior is provided for the near-atmospheric-pressure operating mode or the interior is provided for the vacuum-pressure operating mode.

9. The entrance portion according to claim 5, wherein the at least two parts concentrically overlap via a sealing portion.

10. A material analysis system configured for analyzing a sample, comprising:
a detector for detecting charged particles released by the sample, and
the entrance portion according to claim 1 connected to the detector.

11. A vacuum system comprising:
a vacuum housing configured for vacuum pressure and near-atmospheric pressure for hermetically enclosing a cavity for arranging a sample,
an illumination system for illuminating the sample, and
the material analysis system according to claim 10 for analyzing the sample.

12. A method for selectively operating the entrance portion according to claim 1 in a vacuum-pressure operating mode or a near-atmospheric-pressure operating mode, comprising the steps of:
selecting the near-atmospheric-pressure operating mode or the vacuum-pressure operating mode, and
providing the interior depending on the selected operating mode, such that the interior is provided in the near-atmospheric-pressure operating mode such that a near-atmospheric pressure from the distal end of the interior to its proximal end is reduced to a vacuum pressure, and the interior is provided in the vacuum-pressure operating mode such that a solid angle occupied by the charged particles released by the sample and extending into the interior and a distance between the sample and the distal end of the interior is greater in the vacuum-pressure operating mode than in the near-atmospheric-pressure operating mode.

13. A method for selectively analyzing a material in a vacuum-pressure operating mode or a near-atmospheric-pressure operating mode using the vacuum system according to claim 11, comprising the steps of:
providing a sample in the vacuum housing of the vacuum system,
selecting the near-atmospheric-pressure operating mode or the vacuum-pressure operating mode.
providing the interior depending on the selected operating mode, such that the interior is provided in the near-atmospheric-pressure operating mode such that a near-atmospheric pressure from the distal end of the interior to its proximal end is reduced to a vacuum pressure, and the interior is provided in the vacuum-pressure operating mode such that a solid angle occupied by the charged particles released by the sample and extending into the interior and a distance between the sample and the distal end of the interior is greater in the vacuum-pressure operating mode than in the near-atmospheric pressure operating mode,
adjusting the pressure upstream of the distal end of the interior of the entrance portion depending on the operating mode, such that in the near-atmospheric-pressure operating mode, near-atmospheric pressure prevails upstream of the distal end of the interior and in the vacuum-pressure operating mode, vacuum pressure prevails upstream of the distal end of the interior,
illuminating the sample with the illumination system, and
detecting charged particles released by the sample in the detector.

14. The vacuum system according to claim 11, which is effective for performing at least one member selected from the group consisting of:
a surface analysis,
a measurement of a surface reaction,
a measurement of liquid-solid reactions,
a measurement of liquid-gas reactions,
a measurement of liquids,
a measurement of thin layers,
a detection of foreign substances in liquids,
a photoemission measurement,
a photoelectron spectroscopy measurement close to atmospheric pressure,
an X-ray photoelectron spectroscopy measurement close to atmospheric pressure,
an electrochemical measurement,
a battery analysis,
an oxidation measurement,
an electrolyte measurement,
an electrode measurement,
a sample measurement through a liquid,
a quality control,
a corrosion measurement,
a catalyst measurement,
a pressure-dependent measurement,
a measurement of a biological sample,
a potentiometry measurement,
a measurement of a supersaturated liquid, and
an analysis of microelectronic devices.

15. The method according to claim 13, further comprising a member selected from the group consisting of:
a surface analysis,
a measurement of a surface reaction,
a measurement of liquid-solid reactions,
a measurement of liquid-gas reactions,
a measurement of liquids,
a measurement of thin layers,
a detection of foreign substances in liquids,
a photoemission measurement,
a photoelectron spectroscopy measurement close to atmospheric pressure,
an X-ray photoelectron spectroscopy measurement close to atmospheric pressure,
an electrochemical measurement,
a battery analysis,
an oxidation measurement,
an electrolyte measurement,
an electrode measurement,
a sample measurement through a liquid,
a quality control,
a corrosion measurement,
a catalyst measurement,
a pressure-dependent measurement,
a measurement of a biological sample,
a potentiometry measurement,
a measurement of a supersaturated liquid, and
an analysis of microelectronic devices.
